(19) United States
(12) Patent Application Publication
(10) Pub. No.: US 2020/0101374 A1
(43) Pub. Date: Apr. 2, 2020

(54) Modular Simulator System and Apparatus

(71) Applicant: MICHAEL BUCHHEISTER, EMMITSBURG, MD (US)

(72) Inventor: MICHAEL BUCHHEISTER, EMMITSBURG, MD (US)

(21) Appl. No.: 16/146,803

(22) Filed: Sep. 28, 2018

(51) Int. Cl. A63F 13/245; A63F 13/285; A63F 13/215; A63F 13/235; G09B 9/058

(52) U.S. Cl. CPC A63F 13/245; A63F 13/285; G09B 9/058; A63F 13/235; A63F 13/215

(57) ABSTRACT

A modular multi-axis simulator system for use in concert with a graphical display, gaming console/computer at an affordable scale is described. The simulator is equipped with at least one modular seat, which may be easily interchanged by the owner for differing seats which correspond to the programmed experience. The seat is disposed within a set of rings, which are configured to rotate, facilitating shift and rotation of the seat(s) about multiple axes. The shifting, rotating, and vibrating of the seat(s) occurs such that the movements correspond to visual stimuli presented via the computer/console and graphical display. Additional features such as wind simulation, a odor emission, a solenoid-equipped body suit, and a VR headset may be added to further enhance the experience, providing enhanced realistic simulation within one's home.

### FIELD OF THE PRESENT INVENTION

The present invention relates in general to simulators, and more specifically relates to an affordable virtual reality simulator configured to move a user via at least one motor on a multi-axis gyroscopic apparatus, configured to correspond to virtual visual stimuli for multiple application uses.

### BACKGROUND OF THE PRESENT INVENTION

Virtual reality machines have been gaining prominence nationwide as an amusement or entertainment mechanism designed to immerse one or more individuals such that the entire body of the individual(s) moves in perfect tandem with visual cues on a screen, or within a headset displaying at least one screen to the individuals. Such machines are often found at amusement parks, museums, and similar tourist attractions. Customers would even line-up to pay to enjoy the simulated ride, be it a rollercoaster simulation, a space craft flight simulation, or other simulated experience.

Unfortunately, the modular scale of such simulators presently on the market is severely limited. Once constructed, the simulator has no means of conversion to drastically different visual stimuli. For example, in the conventional rollercoaster simulator, at least two ‘rollercoaster-style’ seats are generally present within the cockpit of the simulator, which are built-in to the floor of the simulator (especially in simulators in which the users are inverted). These seats are not modular, and as such, the simulator is designed for a single program or type of program. Such simulators are prohibitively expensive for personal ownership.

Unfortunately, these machines often amount to a box-shaped cockpit supported by at least one motorized arm, configured to shake and move the inhabitants (users) in accordance with visual cues on the screen. These basic simulators progressed to multi-axis cockpits, capable of inverting the inhabitants, rolling them at angles portrayed on the visual display. Due in part to their shape and complexity, these simulation machines are prohibitively costly to own, and therefore only private companies or the wealthy own them.

Presently, enjoying such an experience on an end-user scale, such as at one's home, can cost upwards of $500,000. If there were a more efficient and less expensive means by which simulators could be constructed, more individuals could enjoy simulations at home, or within small businesses. Additionally, software development for such a system would be proliferated, as more users would be available to purchase developed software for use in a private setting.

Thus, there is a need for a new form of virtual reality simulator, configured to integrate state-of-the-art motorized movements in concert with visual stimuli, which is manufactured with light-weight, affordable components such that middle-class or moderately wealthy individuals may purchase for their own home use. Such a system is preferably modular, and is able to serve a wide variety of entertainment purposes, from interactive film displays and experiences, to fully fledged games. The modular nature of such a system enables the owner to exchange the seat within the cockpit to that of a motorcycle seat with handlebars, a racing bucket seat, a rollercoaster seat, treadmill deck, or other seats corresponding to the game/software/movie utilized and shown on the graphical display. Such a system would preferably be installed in a garage or basement.

### SUMMARY OF THE PRESENT INVENTION

This Summary of the Invention is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is a modular simulator system for use in tandem with a virtual reality headset, multiple monitors, or a spherical (or oval) screen to provide a seamless entertainment experience for one or more users. The present invention is equipped with a modular seat, configured to be easily interchanged with other seat formats which are more conducive to mimicking the visual stimuli presented. The modular seat is preferably disposed within a cockpit of the simulator, and is supported by one or more seat mounts. Additionally, the present invention is equipped with a multi-axis mounting system which facilitates manipulation of the cockpit in a realistic fashion in tandem with the perceived effects and experiences portrayed on the display or VR headset. A treadmill deck or platform may also be installed in the cockpit area of some embodiments of the present invention in lieu of a seat, which similarly acts as a human input mechanism.

The present invention is configured to function in tandem with a computer or conventional HD gaming system/console such as a Microsoft™ XBOX ONE™, Sony™ PlayStation™, Nintendo™, or other known gaming system. The present invention preferably pairs wirelessly to the system/console via Bluetooth™ or Wi-Fi, similar to a conventional wireless controller, in order to facilitate manipulation of the software/game by the user(s). Alternate embodiments may be configured to directly connect to the console or computer with one or more wires.

The system of the present invention preferably includes accessories which facilitate more complete immersion into the experience/content. For example, a solenoid-equipped flight suit is preferably an optional addition to the system of the present invention, which is preferably equipped with solenoids in communication with small rods. The rods, actuated by the solenoids, are configured to poke at the skin of the user when worn in accordance with stimulus from the software. For example, if the user is shot or crashes within the game software experience, the solenoids poke into the skin of the user at the location of the injury as represented on the screen(s), adding authenticity to the simulation experience provided by the system of the present invention.

Additionally, the cockpit of the present invention is preferably equipped with one or more fans to provide a simulated experience of wind when the software exhibits a windy environment. For example, a user could be running a flight simulator program/game, in which he or she is piloting an open-cockpit plate. In such a case, the fan(s) would be activated to simulate the effect of wind, as well as smell via an odor diffusion box. At least one of the fans is preferably disposed beneath the front graphical display(s).

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a schematic of the system of the present invention, detailing the preferred placement of the components of the system of the present invention.

FIG. 2 depicts a close-up view of a front of the cockpit, seat, and counterweight of the mount of the present invention.

FIG. 3 shows a flow chart detailing the process of use of the present invention by a user.

FIG. 4 details a rear side view of the present invention, detailing the multi-axis mount, motors, and sled.

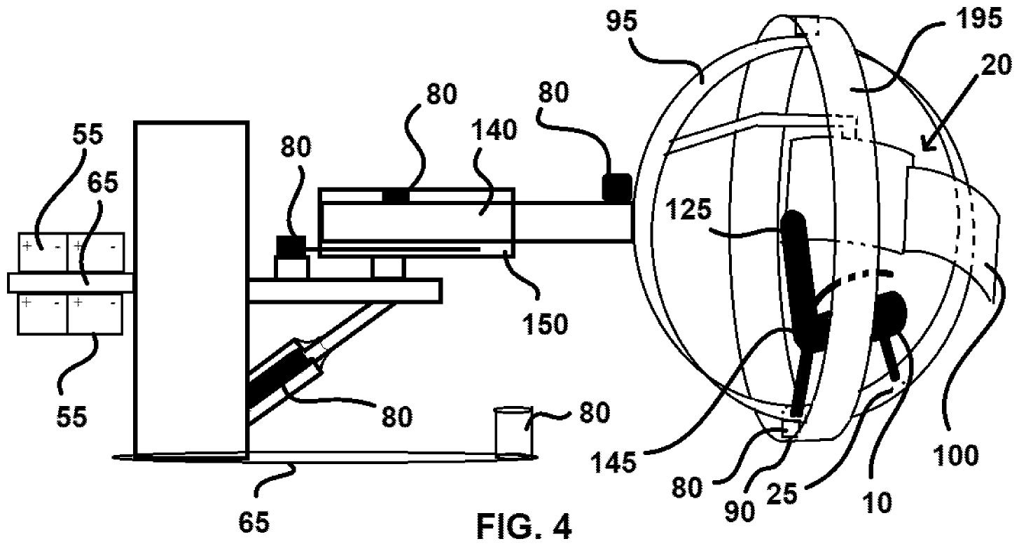

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is an affordable simulator solution configured for use within homes and businesses to provide accurate simulations in accordance with films and simulator programs (software/games). The preferred embodiment of the present invention is equipped with at least one seat (10), disposed within a central cockpit area (20). The central cockpit area (20) is disposed at a center of a multi-axis mount (30), comprising a first axis (40) and a second axis (50). The first axis (40) is equipped with a first inner rotator (60) configured to rotate the user within the circular center of the first axis (40). Additionally, the second axis is equipped with a second inner rotator (70), configured to enable the rotation of the entirety of the first axis (40) and cockpit area (20) of the simulator.

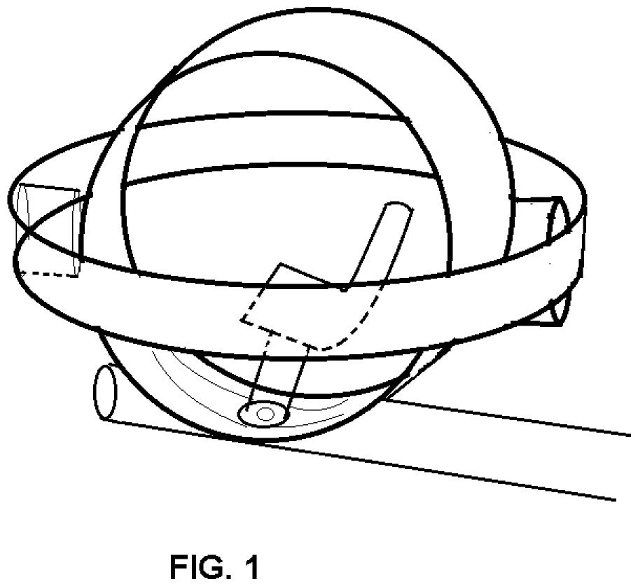

Each of the rings (95) are preferably equipped with an inner portion (185) and an outer portion (195) as seen in FIG. 1. The inner portion (185) is separated, and buffered by, a series of metallic balls (170), which enable the inner portion (185) to rotate freely within (and against the reference of) the outer portion (195) of each ring, facilitating stability and additional range of movement. The inner portion (185) is configured to rotate in a direction opposing the outer portion (195).

It should be understood that the first inner rotator (60), second inner rotator (70), and outer rotator (85) amount to rings (95), which are preferably made of aircraft grade aluminum which are present around the cockpit area (20), facilitating motion of the cockpit area (20) during use of the present invention. Aluminum is preferably used to keep the cost of the system down, as well as to keep the weight of the apparatus low. It is envisioned that at least one of the rings may be composed of a durable nylon material. The cockpit area (20) is preferably equipped with speakers (125) which are ideally oriented to cast sound in the direction of the user, and provide an immersive, three-dimensional surround sound audio experience. The cockpit area (20) is preferably equipped with a plastic shell. Motors (80) are configured to convey motion to junctions (90) of each axis, providing the system of the present invention with mechanized movement in accordance with visual stimulus, which is provided via a graphical display (100).

The graphical display (100) of the present invention is preferably one or more display screens, or in some embodiments, a VR headset is used. The graphical display (100) may be a form of one or more curved screens disposed in the front and the rear of the user within the central cockpit area (20). A computer (110) is preferably disposed in communication with the motors (80) as well as the graphical display (100) in order to coordinate the movement of the axes in accordance with the visual cues depicted on the graphical display (100). The graphical display (100) may exhibit a global radius screen capable of occupying at least ⅓ of the view area of the user. The computer (110) may be a conventional computer or gaming console. A human interface device (120) may also be present to enable the user manipulation of the content.

The at least one seat (10) is preferably modular such that it may easily be removed from the system by the user, and replaced with a suitable seat compatible with the system of the present invention. For example, the user may opt to exchange a bucket-style racing or flight seat for a motorcycle or bike seat equipped with handlebars. In such embodiments, the handlebars embody the human interface device (120), providing for manipulation of speed and direction of a motorcycle simulation.

To facilitate control of the software via the motorcycle-styled seat via leaning, a first air piston is disposed at a left side of the motorcycle-styled seat, and a second air piston (air cylinders) is present at a right side of the motorcycle-styled seat. The air pistons/cylinders ensure that the user cannot lean too far to one side, causing injury or damage to the present invention. The air pistons also prevent rapid leaning, and enable the user to gradually lean, in an analog motion, to facilitate precise control over the software.

The at least one seat (10) is preferably equipped with a four-point shoulder harness (15) to ensure the safety of the user, especially during inverted movement. The shoulder harness (15) preferably straps over both shoulders of the user, to keep him or her in position during use. Optionally, some uses of the present invention may indicate a lack of seat, and instead, the user may employ a treadmill to traverse a simulated landscape. In such embodiments, the treadmill acts as the human interface device (20), permitting manipulation of the graphical presentation portrayed on the graphical display (100) in accordance with steps taken on the treadmill. In such embodiments employing a treadmill deck, a curved display screen is preferably used as the graphical display (100) to provide an immersive experience.

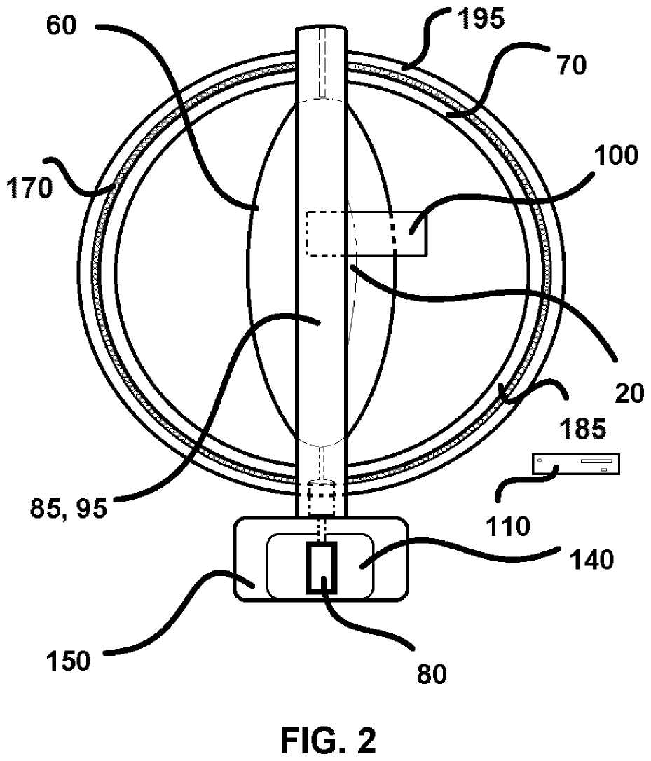

A robust support and mounting system is required to ensure that the present invention remains stationary (in relative position) when in use, ensuring the prevention of injury. A one-piece lever (65) is preferably present to facilitate balancing of the cockpit area (20) about a pivot point (75), as shown in FIG. 2. On one end of the one-piece lever (65) rests the counter-weight(s) (55), and on a second end of the one-piece lever (65) rests the cockpit area (20) surrounded by the rings (95). The counter-weight(s) (55) preferably stabilize and balance the cockpit area (20), including the rings (95), ensuring that use of the present invention is safe even during vigorous movement/maneuvers provided by the simulation. In preferred embodiments of the present invention, a camshaft wheel is disposed under the seat (10), which is configured to compensate for turbulence and vibration of the motors (80) when they are in operation.

Seven variable speed motors (80) are preferably employed by the system of the present invention, however additional motors (80) may be purchased with upgraded (add-on) components of the present invention to add additional features. The motors (80) may be configured to jump from 110 v to 220 v depending on the demand. Each motor (80) is in communication with at least one belt (65) configured to convey motion to one or more rings (95) of the present invention. In the preferred embodiments of the present invention, there are two motors (80), each with at least one belt (65), for each the second inner rotator (70) and the outer rotator (85) of the rings (95). Movement of the central cockpit area (20) itself is preferably gear driven, whereas up and down movement of the entirety of the apparatus is driven by motors (80) with threaded shafts, or may be hydraulic.

Counterweight(s) (55), preferably in the form of batteries, are present to maintain stability of the system and apparatus of the present invention during use. The counterweights (55) are preferably integrated into a sled housing (150) disposed at a rear of the present invention. However, in alternate embodiments of the present invention, the counterweights (55) may be disposed at any point of the rear of the assembly of the present invention.

Brakes are preferably disposed on a main drive rod for safety and to facilitate gradual slowing (or emergency stopping) of the rings (95). The brakes are preferably rounded, and need not be hydraulic; however, some embodiments of the present invention may employ a hydraulic brake. Hydraulics may be employed to facilitate movement of the apparatus as a whole up and down, with the counterweight(s) maintaining stability during movement.

The seat (10) of the present invention is preferably affixed to a quick release mounting plate (135), which is held in position by bolts (25) and nuts. Preferably at least four bolts (25) are required to ensure that the seat (10) remains in a safe position during use. Each alternative seat (10) compatible with the present invention is similarly equipped with a quick release mounting plate (135) to enable the user to exchange seats without additional assistance or tools. As such, latches may alternatively be employed, similar to those used in the mounting of a vehicle seat within a motor vehicle (such as a minivan with removable seats) to facilitate easy exchange of seats (10) within the cockpit area (20) of the present invention. In other embodiments, metal prongs may be used to secure the seat (10) within the cockpit area (20), which are preferably secured with cotter pins.

Each embodiment of the seat (10) of the present invention is equipped with vibration motors (145) which are configured to provide vibration feedback to the user during active use of the present invention. The vibration feedback accomplished via the vibration motors (145) correlates to events displayed on the graphical display (100). Additionally, some embodiments of the present invention may be equipped with an electrical feedback mechanism, which facilitates the transmission of an electric shock to the advanced (18 and up) user.

Additionally, the present invention is preferably equipped with a smell feedback system, which is accomplished via an odor displacement box (175). The odor displacement box (175) is configured to circulate specific odors/aromas that correlate to the simulated experience.

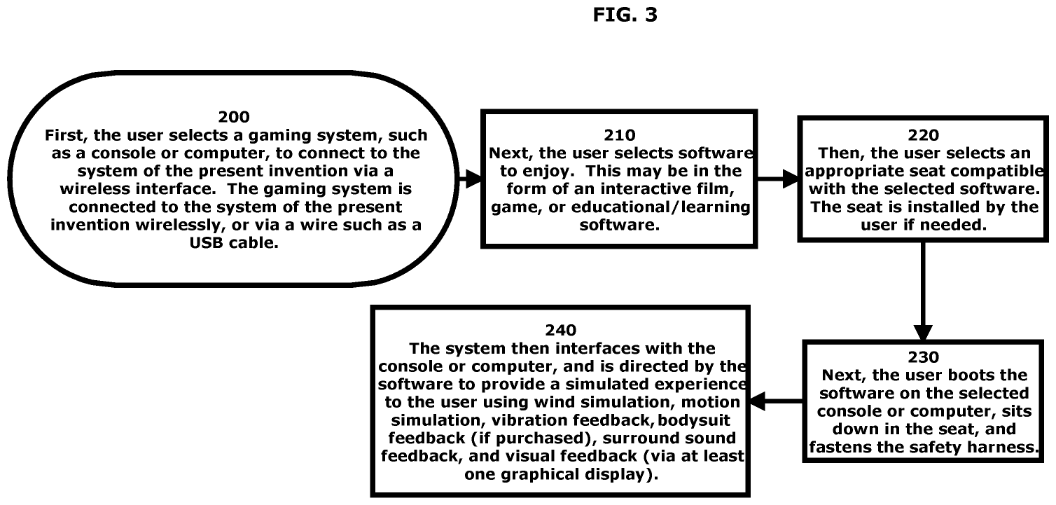

The process of use of the system of the present invention, as experienced by the user, as shown in FIG. 3, is preferably as follows:

1. First, the user selects a gaming system, such as a console or computer, to connect to the system of the present invention via a wireless interface. The gaming system is connected to the system of the present invention wirelessly, or via a wire such as a USB cable. (200)

2. Next, the user selects software to enjoy. This may be in the form of an interactive film, game, or educational/learning software. (210)

3. Then, the user selects an appropriate seat compatible with the selected software. The seat is installed by the user if needed. (220) If only one form of seat is available, the user uses the available seat until a new modular seat (for potentially different software) is purchased as an add-on.

4. Next, the user boots the software on the selected console or computer, sits down in the seat, and fastens the safety harness. (230)

5. The system then interfaces with the console or computer, and is directed by the software to provide a simulated experience to the user using wind simulation, motion simulation, vibration feedback, bodysuit feedback (if purchased), surround sound feedback, and visual feedback (via at least one graphical display). (240)

It should be understood that the preferred embodiment of the present invention is configured to move laterally via a sled (140) which slides within a sled housing (150). This facilitates forwards and backwards movement of the entirety of the rings (95) and cockpit area (20) of the present invention. The rings (95) are preferably welded to a mount of the sled (140) to facilitate safe and stable motion of the user within the cockpit area (20) of the present invention.

Alternate embodiments of the present invention preferably include variations on the sizing, material composition, coloration, and aesthetic design of the present invention. It is envisioned that the preferable materials include fiberglass and lightweight metals such as aircraft-grade aluminum.

An optional addition to the system of the present invention is a solenoid-equipped bodysuit to be worn by the user during use of the present invention. The bodysuit has solenoids distributed throughout the fabric of the bodysuit, which are configured to poke into the skin of the user while not piercing the fabric of the bodysuit. The solenoids of the bodysuit are configured to react to in-game stimulus to further enhance the simulation experience. For example, the solenoids are configured to extend if the user is shot in a shooting game, or crashes in a driving game. With appropriate mapping of the solenoids of the bodysuit, specific solenoids can be activated which correlate to the in-game location of the user's body avatar (character) such that the user feels a sensation at the same bodily location at which his/her character is shot in the game simulation. The bodysuit preferably amounts to a fiber-wired matrix suit, and is preferably available in a variety of sizes to best suit the user.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A simulator system comprising:
motors, each motor in communication with at least one belt;
rings, said motors disposed in communication with said rings via said at least one belt;
at least one seat, said at least one seat disposed within said rings;
wherein said rings have the appearance of large ball bearings;
wherein said at least one seat is housed within a cockpit;
a support, said support disposed beneath said rings;
connecting axes, said connecting axes disposed between said rings, linking said rings to one another;
bearings, said bearings disposed at said connecting axes;
at least one microprocessor, said at least one microprocessor in communication with said motors;
at least one graphical display;
wherein said at least one microprocessor is configured to control the speed of said motors such that movement of said rings effected by said motors corresponds to visual stimuli presented on said at least one graphical display;

2. The system of claim 1, wherein said at least one graphical display is disposed in front of said seat; and
wherein said at least one graphical display is disposed behind said seat.

3. The system of claim 2, wherein said at least one graphical display is spherical.

4. The system of claim 2, further comprising:
a seat belt, said seat belt in communication with said seat; and wherein said seatbelt is a four-point dual shoulder harness.

5. The system of claim 1, further comprising:
at least one fan, said at least one fan disposed beneath said at least one graphical display; and
wherein said at least one fan is configured to direct air towards said at least one seat to simulate wind.

5. The system of claim 1, wherein for each instance of motor there is at least one belt in communication with said motor.

6. The system of claim 5, further comprising:
a helmet, said helmet equipped with a headset and microphone; and
wherein said headset and microphone are integrated into said helmet.

7. The system of claim 1, wherein said at least one seat is modular such that it may be swapped for a different compatible seat; and
wherein said at least one seat is designed for use with specific software.

8. The system of claim 7, wherein said at least one seat is a bucket-styled racing seat.

9. The system of claim 7, wherein said at least one seat is a motorcycle-styled seat;
wherein said motorcycle-styled seat is configured to function as a user interface device such that, a lean to the left effects a change towards the left on the graphical display; and
wherein said motorcycle-styled seat is configured to function as a user interface device such that, a lean to the right effects a change towards the right on the graphical display.

10. The system of claim 9, further comprising:
a left piston, said left piston configured to regulate the lean of said motorcycle-styled seat when leaning to the left; and
a right piston, said right piston configured to regulate the lean of said motorcycle-styled seat when leaning to the right.

11. The system of claim 5, wherein said rings are composed of aircraft-grade aluminum; and
wherein an outermost ring has more internal resistance an said innermost ring of said rings.

12. The system of claim 1, further comprising:
a body suit, said body suit configured to be worn when seated within said at least one seat;
solenoids, said solenoids disposed within fabric of said body suit;
rods, said rods in communication with said solenoids; and
wherein said rods are configured to extend towards an inside of said body suit when said solenoids are activated by said software.
